(19) United States
(12) Patent Application Publication
(10) Pub. No.: US 2020/0252455 A1
(43) Pub. Date: Aug. 6, 2020

(54) SYNCHRONIZATION SERVER FOR CLIPBOARD AND SYNCHRONIZATION SYSTEM FOR CLIPBOARD HAVING THE SAME

(71) Applicant: KNOWCK CO., LTD., Seoul (KR)

(72) Inventors: Jeeyun AHN, Kyunggi-Do (KR); Minho CHOI, Seoul (KR)

(73) Assignee: KNOWCK CO., LTD., Seoul (KR)

(21) Appl. No.: 16/740,969

(22) Filed: Jan. 13, 2020

Related U.S. Application Data
(63) Continuation of application No. 13/848,662, filed on Mar. 21, 2013, now abandoned.

(30) Foreign Application Priority Data
Jul. 18, 2012 (KR) 10-2012-0078050

(51) Int. Cl. H04L 29/08

(52) U.S. Cl. CPC H04L 67/1095

(57) ABSTRACT

A clipboard synchronization system and method are provided that allow data in the clipboard to be shared among a plurality of client terminals that share a common account. The system synchronizes the data in the clipboard that may be cut and/or copied from a document or application on a particular client terminal. The system and method also may provide history keeping that may be a listing of the data in the clipboard that is shared by each of the client terminals through synchronization.

### CROSS-REFERENCE TO RELATED APPLICATIONS

This application is a continuation of U.S. patent application Ser. No. 13/848,662 filed on Mar. 21, 2013 and claims priority to Korean Patent Application Serial No. 10-2012-0078050, filed Jul. 18, 2012, the entirety of which is incorporated herein by reference.

### FIELD

The disclosure relates to a synchronization system for a clipboard. In particular, the disclosure relates to a synchronization system that synchronizes in a manner such that a plurality of client terminals having system clipboards may share a common account and are able to share feeds created by cutting and copying particular data in a particular client terminal.

### BACKGROUND

Terminal systems, such as smart phones, tablet PCs, and personal PCs, typically use and execute a proprietary operating system (OS) or an open source platform. These terminal systems also have a memory that is part of the terminal system in which data may be stored. In a Microsoft WINDOWS OS based system, a well-known clipboard may be used to temporarily store data. The clipboard is a memory area that is reserved for space to temporarily store selected data so that after copying or cutting various data including images and text, the selected data can be pasted into the same or other documents. In other words, by using the clipboard to cut, copy, or paste in various application programs such as word processor or excel, data may be copied from one program to another through the clipboard.

Korean public patent 2006-0128196 disclosed technology that enables the user to save data provided by a plurality of application programs on multiple clipboards and afterwards modify/delete/relocate data of the clipboard. Furthermore, Korean public patent 2008-0064824 disclosed technology that enables access to the clipboard that can be shared among multiple participants so that participants of a conversation may share the data on the clipboard.

However, despite the known systems that allows users to “share” the data in the clipboard, there is not a known system that allows the data copied to the clipboard to be automatically sent to a different client terminal and saved. As a result, when a user owns multiple terminal systems, the user is not able to cut and/or copy data into the clipboard from a first terminal system and then paste that data into a document or application running on a second terminal system.

Moreover, inconvenience is another problem for the known systems. Specifically, the known system does not provide any history of the data on the clipboard. The history may ease storage and management of the data in the clipboard for a plurality of client systems possessed by an individual by listing what is finally shared by all client terminals through each of the data synchronizations.

### BRIEF DESCRIPTION OF THE DRAWINGS

FIG. 1 is a brief arrangement diagram representing a synchronization system for a clipboard;

FIG. 2A is a block diagram showing more details of a client terminal of the synchronization system for clipboard, and FIG. 2B is a block diagram showing more details of a client terminal of the synchronization system for clipboard;

FIG. 3 is a block diagram showing more details of a synchronization unit for clipboard of a synchronization system for clipboard;

FIG. 4 is a flow diagram illustrating a process of testing if a novel feed has occurred in a client terminal in a synchronization system for clipboard;

FIG. 5 is a flow diagram illustrating a process of testing if a novel feed has occurred in a synchronization server for clipboard in a synchronization system for clipboard;

FIG. 6 is a diagram illustrating a method of transferring feed in a synchronization system for clipboard;

FIG. 7 is a diagram illustrating a database of the synchronization unit for clipboard of a synchronization system for clipboard;

FIG. 8A illustrates an example of a web client embodiment of the user interface of a client terminal of a synchronization system for clipboard, and FIG. 8B illustrates an example of a web client embodiment of the user interface of a client terminal of a synchronization system for clipboard;

FIG. 9A illustrates an example of an iOS client embodiment of the user interface of a client terminal of a synchronization system for clipboard, FIG. 9B illustrates an example of an iOS client embodiment of the user interface of a client terminal of a synchronization system for clipboard, FIG. 9C illustrates an example of an iOS client embodiment of the user interface of a client terminal of a synchronization system for clipboard, and FIG. 9D illustrates an example of an iOS client embodiment of the user interface of a client terminal of a synchronization system for clipboard;

FIG. 10A illustrates an example of a Windows based client embodiment of the user interface of a client terminal of a synchronization system for clipboard, FIG. 10B illustrates an example of a Windows based client embodiment of the user interface of a client terminal of a synchronization system for clipboard, FIG. 10C illustrates an example of a Windows based client embodiment of the user interface of a client terminal of a synchronization system for clipboard, FIG. 10D illustrates an example of a Windows based client embodiment of the user interface of a client terminal of a synchronization system for clipboard;

FIG. 11A illustrates an example of an Android based client embodiment of the user interface of a client terminal of a synchronization system for clipboard; FIG. 11B illustrates an example of an Android based client embodiment of the user interface of a client terminal of a synchronization system for clipboard; FIG. 11C illustrates an example of an Android based client embodiment of the user interface of a client terminal of a synchronization system for clipboard; and FIG. 11D illustrates an example of an Android based client embodiment of the user interface of a client terminal of a synchronization system for clipboard; and

FIG. 12A illustrates an example of an Macintosh OS based client embodiment of the user interface of a client terminal of a synchronization system for clipboard; FIG. 12B illustrates an example of an Macintosh OS based client embodiment of the user interface of a client terminal of a synchronization system for clipboard; FIG. 12C illustrates an example of an Macintosh OS based client embodiment of the user interface of a client terminal of a synchronization system for clipboard; and FIG. 12D illustrates an example of an Macintosh OS based client embodiment of the user interface of a client terminal of a synchronization system for clipboard.

### DETAILED DESCRIPTION

The disclosure is particularly applicable to a client server based clipboard synchronization system and it is in this context that the disclosure will be described. It will be appreciated, however, that the system and method may also be implemented using cloud computing, in a mainframe/terminal model, as a software as a service model and the like.

The system and method assists in resolving the limitations noted above so that when the synchronization system for clipboard synchronizes the data in the clipboard such that a plurality of client terminals that share a common account are able to share the data/feed that has been cut or copied by a particular client terminal. The system and method may also provide history keeping that eases storage and management for the plurality of client terminals. The history keeping may list the data/feed(s) that are finally shared by all client terminals through each of the data synchronizations.

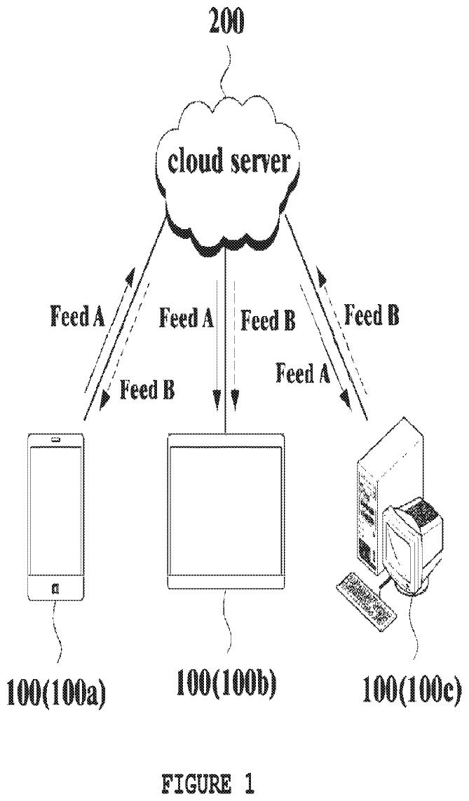

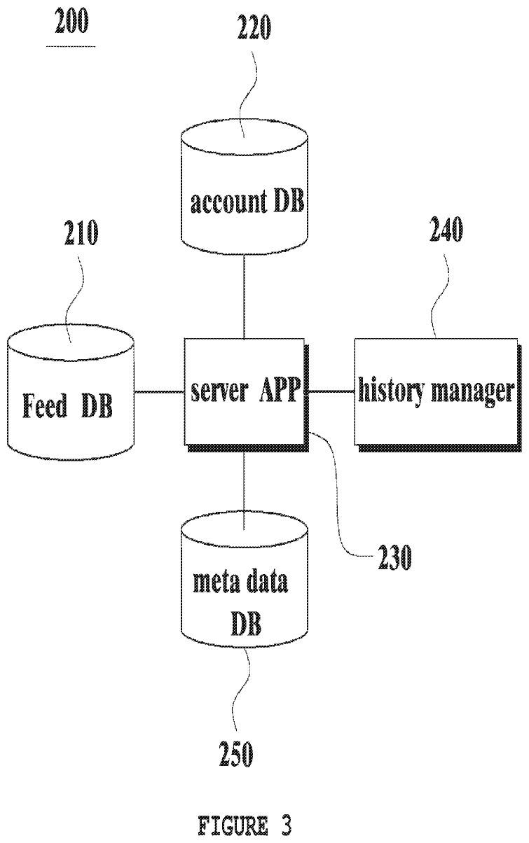

As shown in FIG. 1, the system may have one or more client terminals 100 that interact with a synchronization system 200. Each client terminal may be a computing device as described below in more detail. The synchronization system 200 may be implemented using one or more server computers (details of which are shown in FIG. 3.)

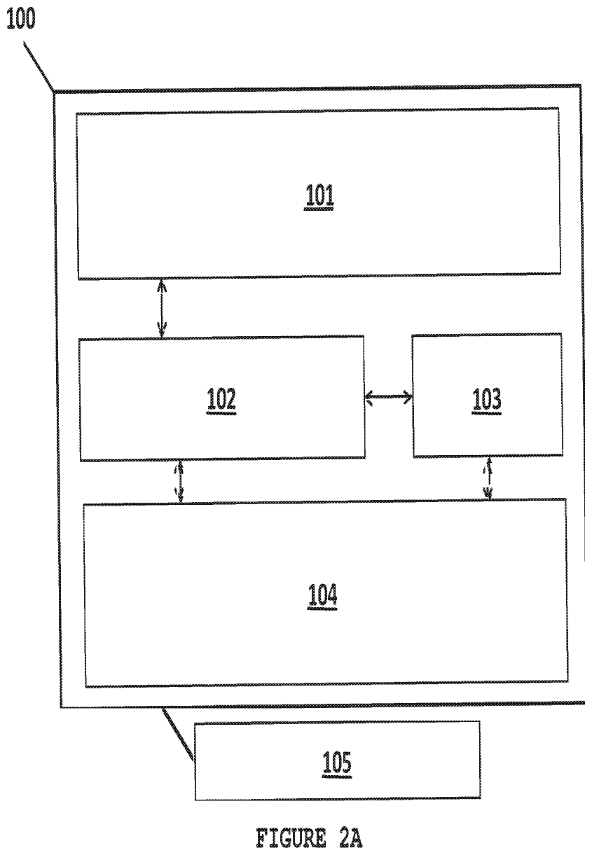

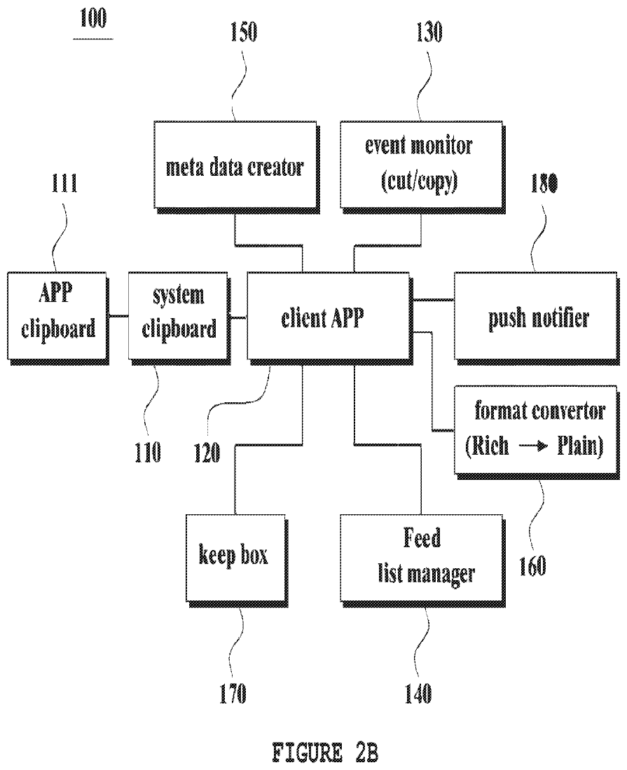

Each client terminal 100 of the system (as shown in FIG. 2) may have a system clipboard 110 that stores the feed(s) created by cutting or copying particular data on the client terminal such as by using an application on the client terminal and the like. Each client terminal 100 also may have a client element 120, such as a software application being executed by a processing unit of the client terminal, that transmits the feed(s) saved in the system clipboard 110 to said synchronization system.

Each client terminal 100 also may have an event monitor 130 which monitors if a feed is saved in the system clipboard due to an event of cutting or copying occurs on the client terminal. The client element 120 may then transmit the feed saved in the system clipboard to the synchronization system when the event is sensed/determined by the event monitor. Each client terminal also may have a feed list manager 140 that manages a list regarding multiple feeds saved in the system clipboard 110. The client element 120 may test if the feed transmitted to the synchronization system is a novel feed distinct from the feed originally saved and managed by the feed list manager. The client element 120 may then transmit the feed to the synchronization system only if it is a novel feed. Each client terminal 100 also may have a meta data creator 150 that creates meta data included within each feed transmitted to the synchronization system. Each client terminal 100 also may have a keep box 170 that is a memory source to store those selected by the use among feeds temporarily saved in the system clipboard, in at least one of said client terminal or synchronization server for clipboard.

Using the system, the method synchronizes a feed created by cutting and copying particular data in a particular client terminal and shares the feed among a plurality of client terminals that share a common account. Also, in the plurality of client terminals, the final result of what is shared by all client terminals through synchronization of each of the formed feeds in multiple client terminals is tracked and may be displayed.

As shown in FIG. 1, a synchronization system for clipboard may have a plurality of client terminals 100 that share a common account and a synchronization system 200 which synchronizes a system clipboard 110 of each client terminal 100 over a link that may be wired or wireless. As shown in FIG. 1, each client terminal may upload a feed and/or download a feed from/to the synchronization system 200. Each client terminal may be included in an individual's possession and each client terminal may be associated with a common account. Each client terminal 100 may be a computing device that is a processing unit based device that is capable of interacting with the synchronization system. For example, each client terminal may be a smart phone 100a, a tablet PC 100b, or a personal PC 100c, but the client terminal may also include a wire or wireless communicator (that allows the client terminal to transmit information, such as the feeds, to the synchronization system, speaker, GPS receiver, memory, data input section/output section, keyboard or touch panel, etc. Each client terminal may generate a feed, that may be a piece of data or an object such as an image or a piece of text, that may be synchronized to the synchronization system 200. In each client terminal 100, if a feed (generally corresponding to a ‘clip’ that is saved in a clipboard) is formed by copying or cutting various data or objects including images and texts, the feed is saved in the system clipboard 110 of the client terminal 100. In addition, each client terminal 100 may transmits the feed to the synchronization system 200 and the synchronization system 200 transmits the transmitted feed to another client terminal 100 that has the common account. The one or more feeds formed in the client terminal 100 may be saved in the system clipboard 110 of each client terminal. Thus, each client terminal 100 has the feeds from the other client terminals that makes pasting simple and free in each client terminal.

As shown in FIG. 2A, each client terminal 100 may include a display 101, one or more processing units 102, such as one or more processors, a persistent storage device 103, such as a hard disk drive, optical drive, flash memory and the like and a memory 104, such as SRAM or DRAM, that are coupled to each other as shown in FIG. 2. When the client terminal 100 is operating, the memory 104 may store an operating system that is executed by the processing units and one or more pieces of software, such as the elements shown in FIG. 2B, that implement the system. Each client terminal 100 may also include one or more input/output devices 105 that are coupled to the other components and allow the user to interact with the client terminal. For example, the one or more input/output devices 105 may be a keyboard, a mouse, a touch sensitive screen and the like.

To achieve this, as shown in FIG. 2B, each client terminal 100 of synchronization system may further include a system clipboard 110, application clipboard 111, client element 120, an event monitor element 130, a feed list manager 140, a meta data creator 150, a terminal side format convertor 160, a keep box 170, and a push notifier 180. In one embodiment, each of the elements may be implemented using a plurality of lines of computer code that may be executed by the processor of the client terminal. The system clipboard 110 and application clipboard 111 may each be a portion of memory into which the piece of data/feed may be stored within the memory 104 of the each client terminal 100. The application clipboard 111 may be a clipboard loaded in Microsoft power point or the clipboard loaded in Microsoft Excel that may be used to cut, copy, and paste clips (i.e., feed) in the corresponding application program. On the other hand, the system clipboard 110 is used for each client terminal 100 to share feed in the terminal system level and the system clipboard is used when the feeds are being cut/pasted between application programs such as MS power point and MS excel. Since it is not known what will happen to feeds of various formats in a certain application program, for compatibility among these application programs, system clipboard 110 accepts objects and data of various forms including text and image.

In the system, if a feed is created/formed by cutting or copying a particular piece of data in client terminal 100, the piece of data is saved in the system clipboard 110. The feed saved in system clipboard 110 may be then transmitted to the synchronization system 200. The synchronization system 200 may then transmit the feed to another client terminal 100 so that the feed is saved in the corresponding system clipboard 110 of the other client terminal. The client element 120 transmits the feed(s) saved in the system clipboard 110 to synchronization system 200. In other words, as explained above, if a novel feed is formed at a client terminal 100, this will automatically be transmitted to other client terminals 100 synchronized of a common account.

The system may use various methods to transmit feed saved in system clipboard 110 to synchronization system 200. For example, polling and push are two examples of such methods that may be incorporated into the client element 120. The polling is a method for transmitting the feed that is most recently saved by the client element 120 during a certain time period (for example, around one second) and the method checks for changes in the feeds by continuously polling the system clipboard 110 once every certain time period. When the system uses a push system that operates like an interrupt, the push system only generates a signal when a change in the feed occurs so a periodic check in not needed. In the push system, when a new feed is detected, the feed may be communicated to the synchronization system 200.

In one implementation, the client element 120 may be implemented as a processor. The client element 120 may also be implemented as a plurality of lines of computer code executed by the processor of the client terminal that are may be downloaded from the synchronization system 200 and installed on the client terminal 100. The client element 120 may incorporate a function to test if the feed transmitted to synchronization system 200 is a novel feed distinct from the feed originally saved and managed by feed list manager 140. More particularly, if the client element 120 monitors the system clipboard 110 to transmit feed to the synchronization system 200 with a predetermined time interval, such as 1 second for example, the synchronization system 200 may store redundant feeds (e.g., a feed that is the same as an already received feed.) Therefore, the client element 120 uses the test to transmit a feed to the synchronization system 200 only if the feed is a novel feed (e.g., a feed that is different from the other feeds received by the synchronization system 200.

FIG. 3 illustrates more details of the synchronization system 200. The synchronization system 200 may be implemented as one or more server computers that store and execute a plurality of lines of computer code or a one or more cloud computing resources that store and execute a plurality of lines of computer code to implement the functions and operations of the synchronization system 200. The synchronization system 200 may have a feed storage device 210, such as a database that may be implemented in hardware or software, that receives and saves feed created in each client terminal by cutting or copying particular data. The synchronization system 200 may also have an account storage device 220, such as a database that may be implemented in hardware or software, that stores account information for each client terminal and a synchronization element 230, that may be implemented as a server application executed by the server computer, that transmits the feed saved in the feed storage device 210 to another client terminal sharing a common account with the client terminal. The synchronization element 230 may determine that the two client terminals have a common account by retrieving data from the account storage device 220.

The synchronization system 200 may also have a history manager 240, that may be implemented in software executed on the synchronization system 200, that manages multiple feeds saved in the feed storage device 210. The synchronization element 230 may have a function to test if the feed transmitted to the other client terminal is a novel feed different from the feed originally saved and managed by the history manager, and transmitting to said other client terminal only if it is a novel feed. The synchronization system 200 may also have a metadata storage device 250 that saves meta data included in the feed transmitted from said client terminal.

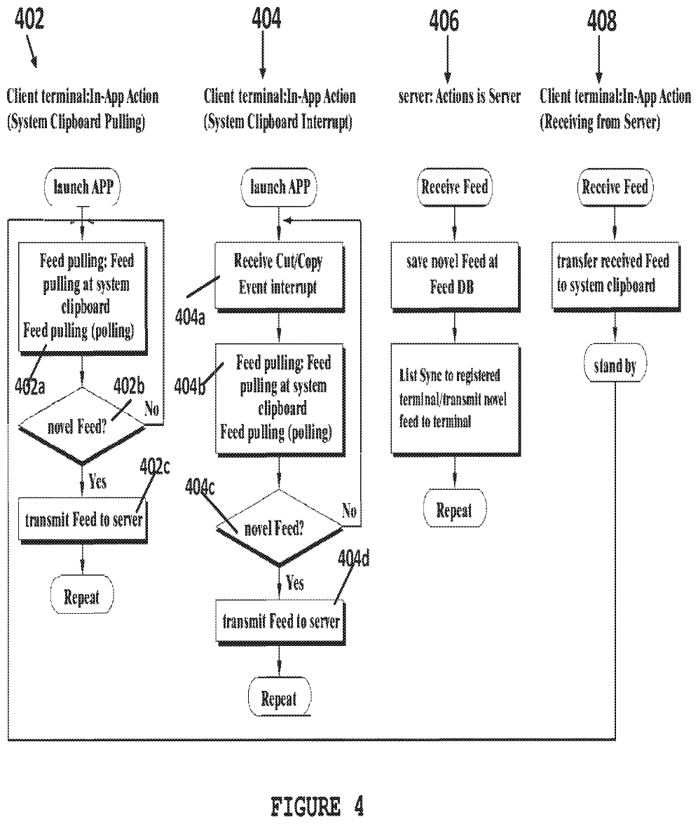

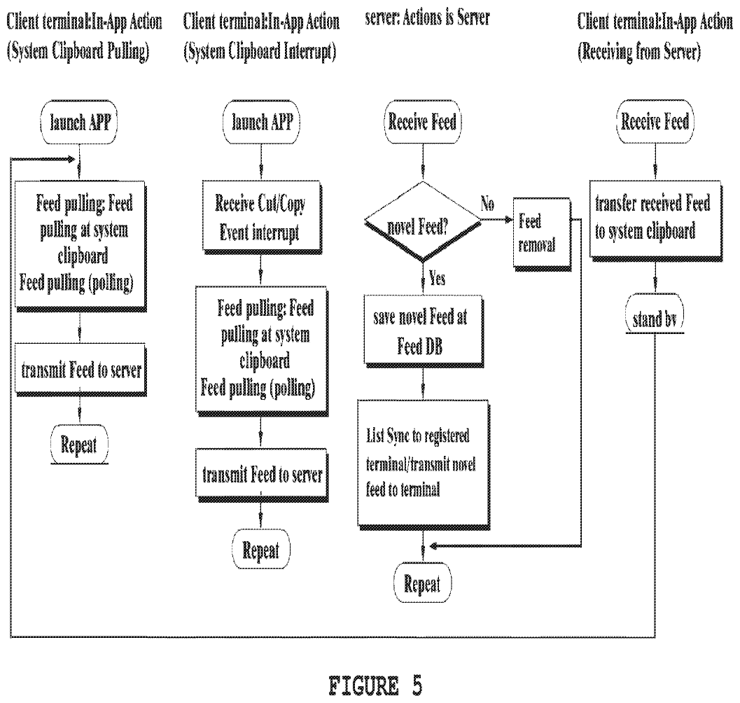

FIG. 4 shows a method of testing if the feed to be transmitted to the synchronization system is novel by running a test on the client terminal 100, i.e. at client element 120. Alternatively, as shown in FIG. 5, the test and the process can be run on the side of synchronization system 200. As shown in FIG. 4, client terminal 100 transmits feed(s) to synchronization system 200 only in case of a novel feed during ‘system clipboard polling’ 402 or ‘system clipboard interrupt,’ 404 using the processes 402a-c and 404a-d shown in FIG. 4. As part of the method, a feed transmitted from the synchronization system 200 (process 406) is directly saved without special testing, and the novel feed is transmitted to another registered (i.e., registered to the same account) client terminal 100 (process 408.)

The client element 120 provides the function of sorting feed lists that are displayed through the display 101 of client terminal 100. The sorting is done based on a user's orders/selections input to the client terminal 100 through the one or more input/output devices 105 of client terminal 100. For example, for sorting, in case of selecting a sorting method according to time, feed is displayed on the screen ordered in the order of creation in either ascending order or descending order. In the case of selecting a sorting method according to the format of the feed, text only, image only, or both are displayed. The sorting can be applied to all synchronized client terminals 100 at the same time. Alternatively, the sorting may be done independently respective to each of the other clients as well. In the case when sorting is done independently, by accessing other client terminals 100, the sorting of the terminal may each be changed through synchronization system 200. For example, the sorting of smart phone 100a can be changed by personal PC 100c.

The event monitor 130 monitors, on the client terminal, if a feed is saved in the system clipboard 110 by the occurrence of a cutting or copying command by the user on the client terminal. The event monitor 130 then provides the client element 120 with the result of the monitoring of event monitor 130 and thus notifies the client element of the occurrence of a novel feed. The event monitor 130 decreases computing throughput and significantly decreases the possibility of transmitting redundant feed to synchronization system 200 since there is no need to monitor system clipboard 110 for every 1 second interval at client application 120, but only monitor system clipboard 110 when an even occurs. However, it is possible for a user to copy or cut the same feed more than once and thus it is preferable to run the test described above. In other embodiments, the function of the event monitor 130 may be incorporated into the client element 120 and since client element 120 may be implemented by a processor, event monitor 130 and client element 120 both may be implemented on a single processor.

The feed list manager 140 manages a list of multiple feeds saved in the system clipboard 110 for each client terminal 100. In feed list management, various types of managements are included, in addition to recording and marking of the time that a feed is saved in the system clipboard 110 and displaying feed saved in system clipboard 110 on the screen of the display 100 of the client terminal 100. In particular, in case there is a feed transmitted from a client terminal is not part of the system, the function of listing the feed list on client terminal 100 and saving only those feeds selected by the user at system clipboard 110 is included. The feed list manager 140 may use various methods for displaying the feed list on the screen of client terminal 100, such as directly displaying original feed consisting of file formats such as image and text, or listing only the file names of the saved feed. Alternatively, the function of list manager 140 may be provided at synchronization system 200, and the management list is downloaded real-time at client terminal 100 and displayed. As explained below, the history manager 240 of synchronization system 200 may provide these functions.

The meta data creator 150 forms meta data relevant to the formed feed and inserts the meta data in the corresponding feed. Meta data may include a variety of information including creation time of feed, file format of feed, and ID of the client terminal 100 feed is created.

Alternatively, the meta data creator 150 function may be implemented by the client element 120 so that the meta data creator 150 and client element 120 may be implemented on a single processor.

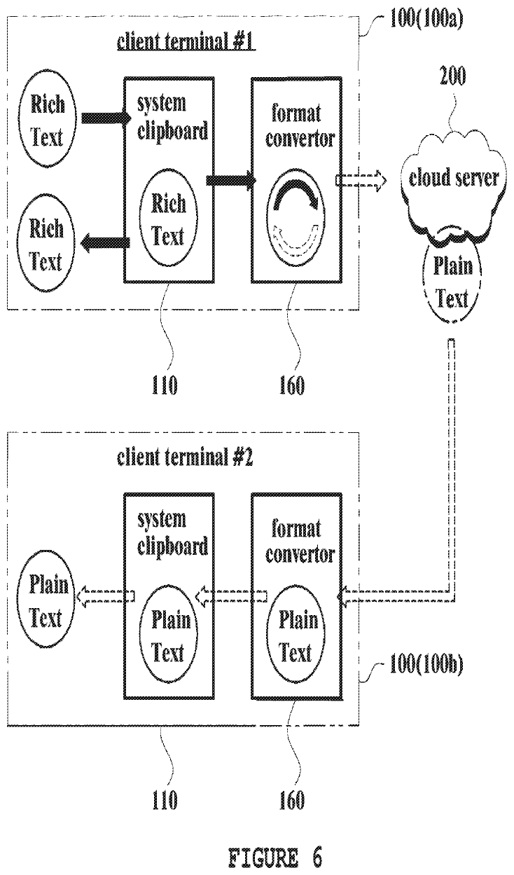

As shown in FIG. 6, a terminal side format convertor 160 may be resident on each client terminal, such as client terminals 100a and 100b shown in the example in FIG. 6. The terminal side format convertor 160 may convert a feed saved in the system clipboard 110 into a format usable even by other client terminals 100 when transmitting the feed to synchronizations system 200. For example, by converting rich text saved in the system clipboard 110 into plain text, the feed of plain text is transmitted to synchronization system 200 as shown in FIG. 6. If rich text is pasted into a Microsoft (MS) WINDOWS notepad, the code is decoded and various formats added to the feed are removed as plain text. The plain text has significantly smaller data capacity and compatibility is guaranteed and thus it is advantageous to save and use plain text feeds in synchronization system 200 and other client terminals 100. Alternatively, the terminal side format convertor 160 may be provided in the synchronization system 200. In this case, the server side format convertor (not shown) to be further explained accomplishes such function, enabling use activating either one of terminal side format convertor 160 or server side format convertor.

The keep box 170 is a memory source for storing feeds selected by the user among those temporarily saved in system clipboard 110. The keep box 170 in each client terminal may provide long-term storage of feeds selected by the user among those displayed on client terminal 100 by feed list manager 140, and permanently stored if there is no particular deletion command.

The system clipboard 110 may use a first in first out (FIFO) method. In the method, for example, if the number of feed exceeds 100, the novel feed is saved and the oldest feed is automatically deleted. Therefore, feeds selected by the user or important feeds (for example, feeds consisting of over 100 letters) are automatically saved in keep box 170. Feeds saved in keep box 170 may be sorted by client element 120. In addition to the keep box on each client terminal, there may also be a keep box (not shown) in the synchronization system 200 as well to enable sharing of the feeds in the keep box at any client terminal 100.

The push notifier 180 push notifies to the user that a situation requiring a motion of foreground has occurred. Such push notifier may set at ‘setting page’ whether to and how to push notify, as explained below. During background motion condition, if novel feed is transmitted from another client terminal 100 or novel feed is created in the corresponding client terminal 100 and a novel feed is accepted, it is push notified for need of foreground condition. A background motion condition denotes a condition in which, while using another application program (for example, MS power point, word, etc.), the clipboard 110 is always monitored and changes in the synchronization system 200 is monitored so that synchronization is realized. The background operation is transparent to the user since it is running in the background. The foreground condition relates to a condition wherein the user is able to directly recognize and use through screen displays, etc., and the condition may be directly controlled through Graphic User Interface (GUI), etc. displayed on the screen.

As shown in FIG. 5, in order to prevent redundant saving of identical feeds by accepting and saving at synchronization system 200 only in case of a novel feed through testing, a test may be run on the synchronization system 200. In other words, at the synchronization system 200, only the case of novel feed is saved at feed storage device 210 and the novel feed may be transmitted to another client terminal 100. In case the feed is not novel, the transmitted feed is discarded (deleted) and prepares to receive the next feed. On the other hand, in the case of a client terminal 100 created feed may be transmitted to the synchronization system 200 without a special testing. Of course, as already explained with reference to FIG. 4, it is possible to save only novel feed at system clipboard 110 after running a test in the client terminal 100, itself.

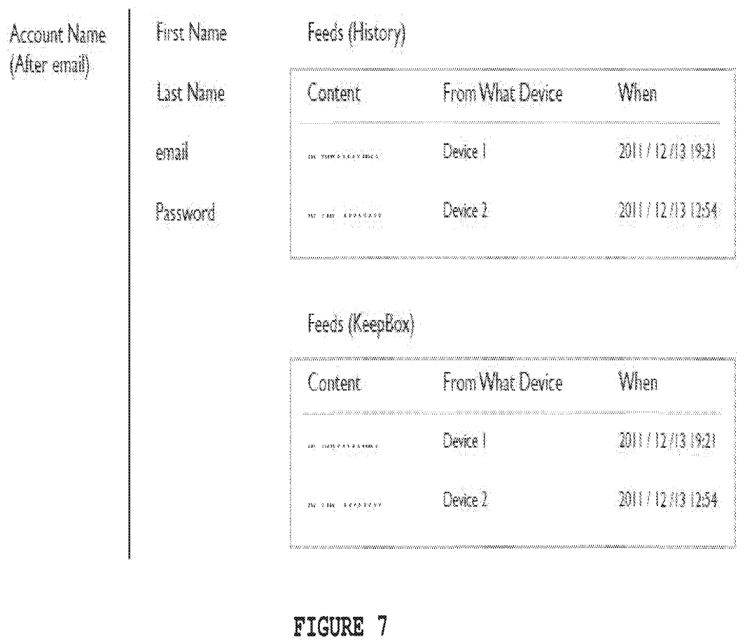

The history manager 240 manages a plurality of feeds saved in feed storage device 210. The history manager 240 operates similarly to the feed list manager 140 of client terminal 100, and the management result is provided to client terminal 100. An example of a page provided by the history manager 240 is shown in FIG. 7, which provides contents displays exhibiting feed together with the user's account, client terminal 100 created and transmitted, created visions, etc. The content display may use various methods such as directly displaying the original feed such as image or text, or listing only the file names of the saved feed.

The history manager 240 displays feeds saved at feed storage device 210 at client terminals 100 accessed to synchronization system 200, if those necessary are selected among feeds shown at client terminal 100 the selected feeds being saved at system clipboard 110 of client terminal 100. In other words, the user may choose feeds to be copied at system clipboard 110 of client terminal 100. However, the disclosure is not limited to this, and in case a feed is displayed at history manager 240 and novel feed occurs, it is possible to have all feeds automatically be saved at system clipboard 110.

The meta data storage device 250 saves meta data included in feed(s) transmitted from client terminal 100. It is distinguishable between client terminal 100 that analyzes meta data and transmits feed and other client terminals 100, thus it is possible to transmit said transmitted feed to another client terminal 100. Also, display as in FIG. 7 is made possible by providing meta data at the history manager 240 as explained above.

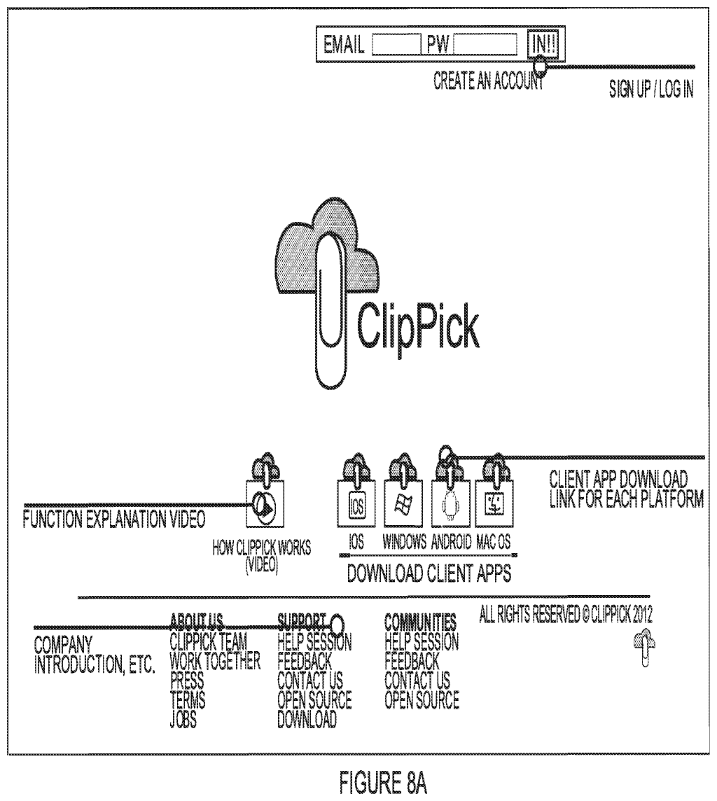

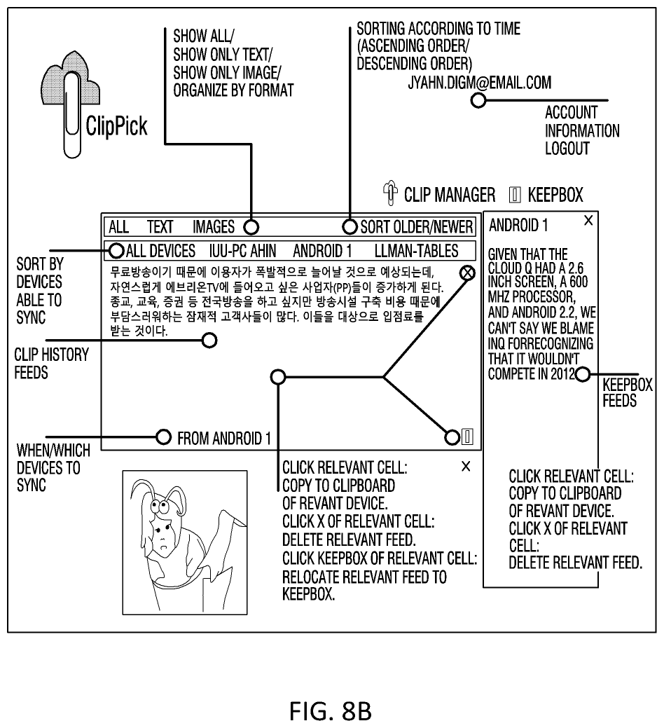

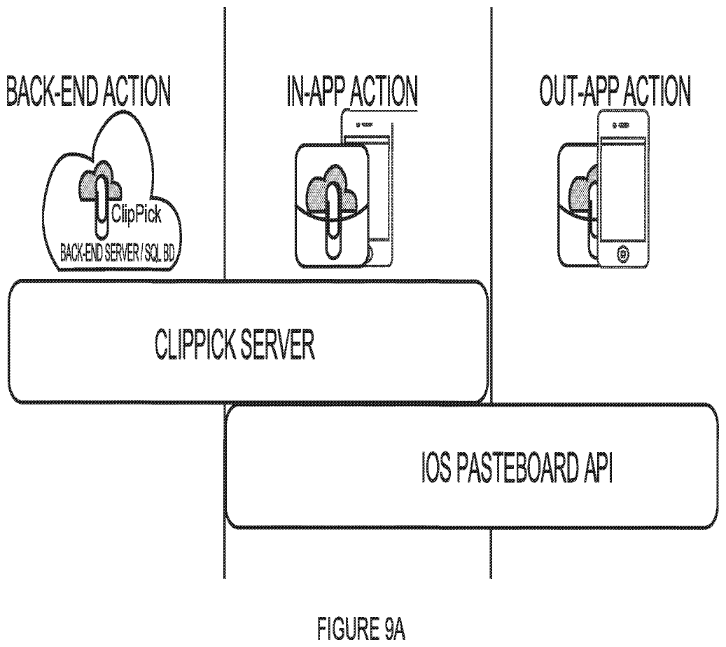

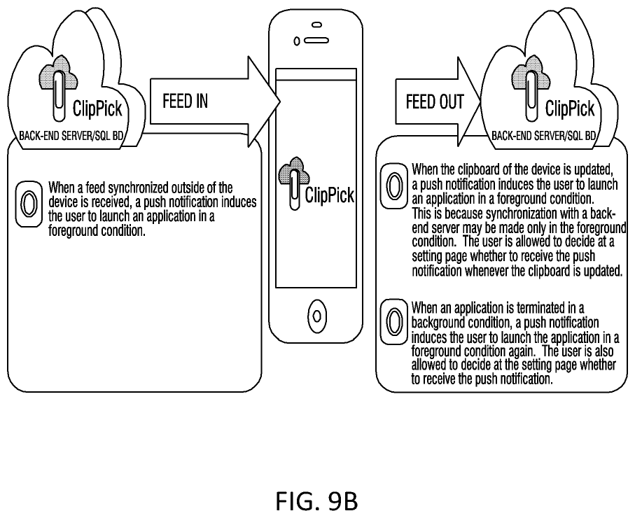

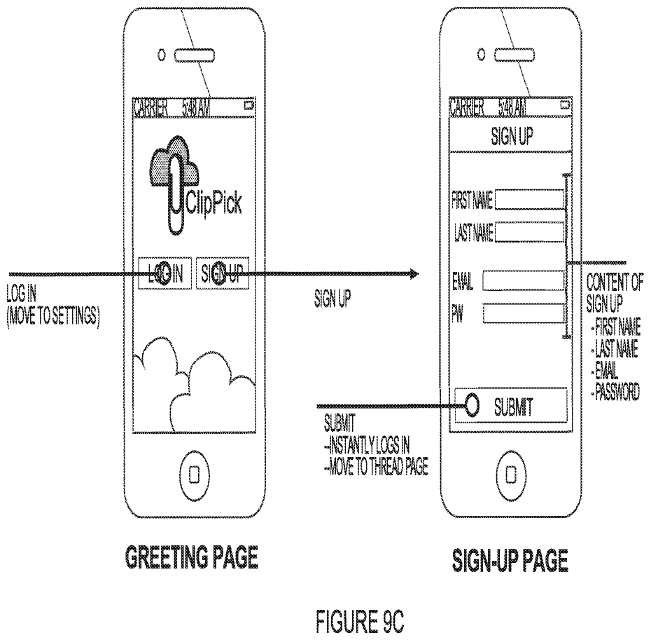

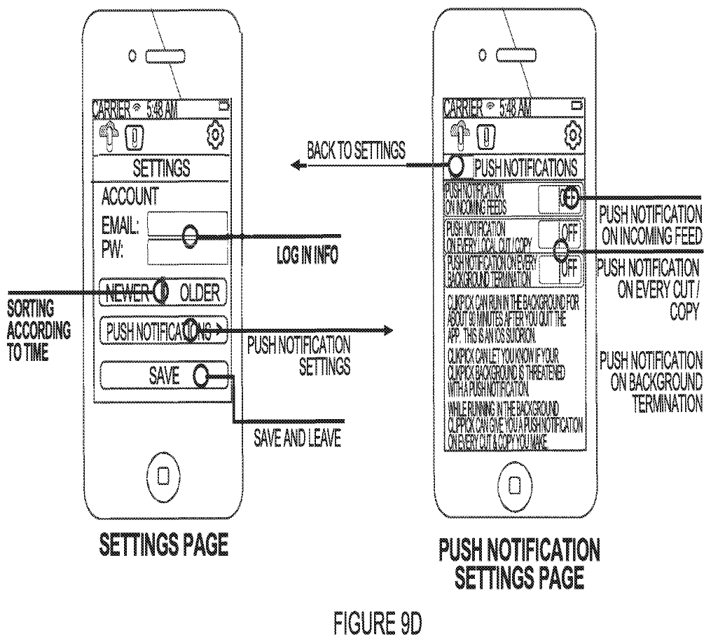

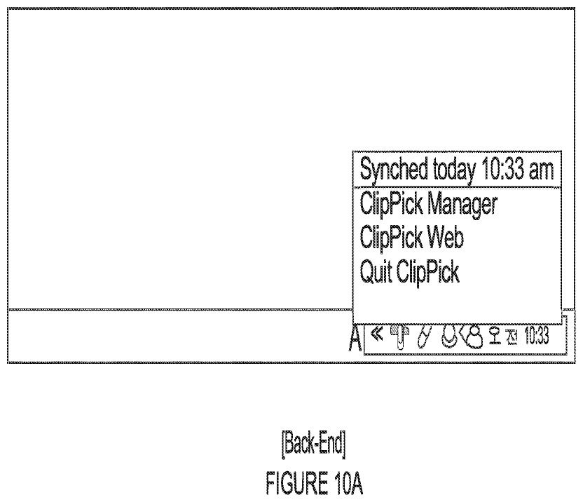

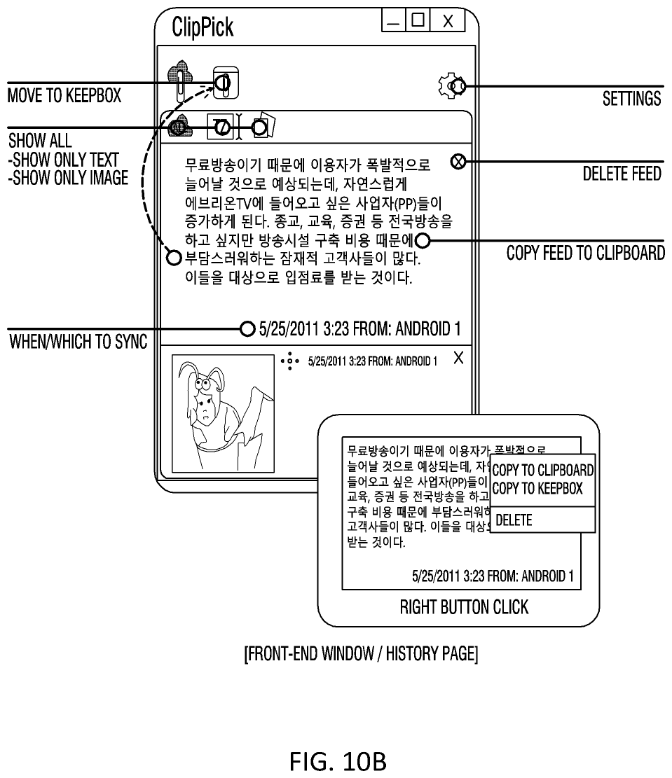

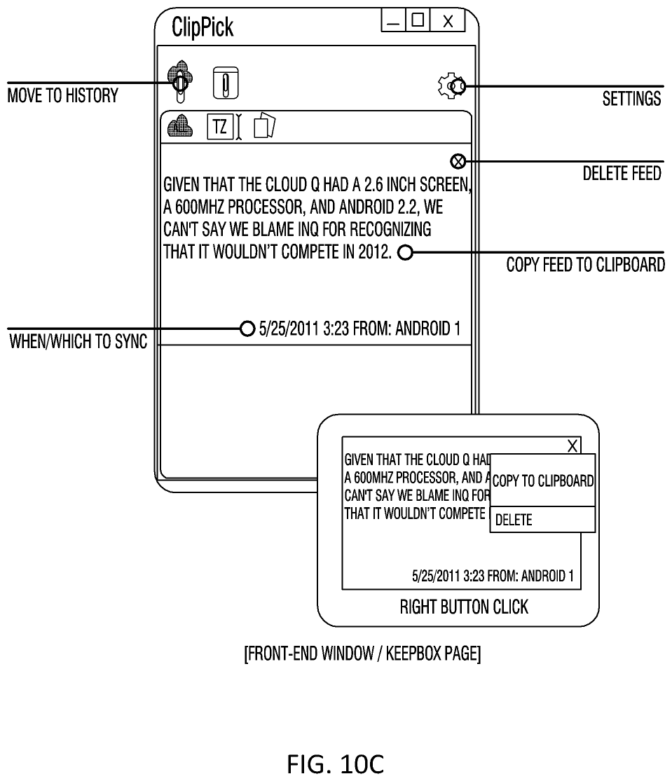

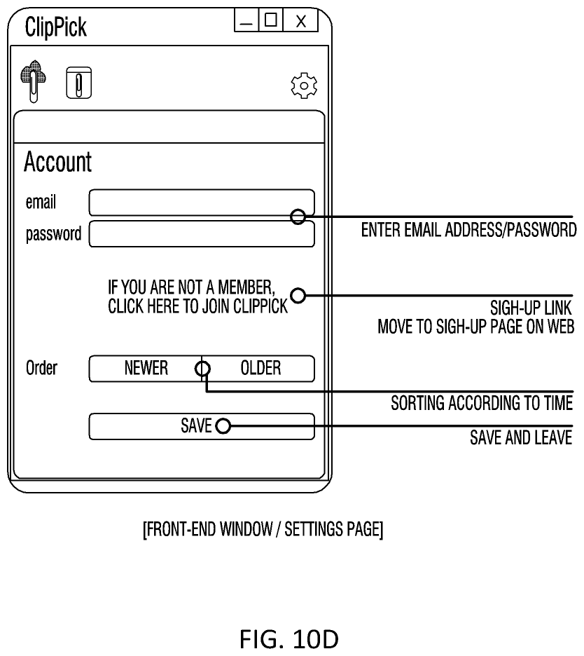

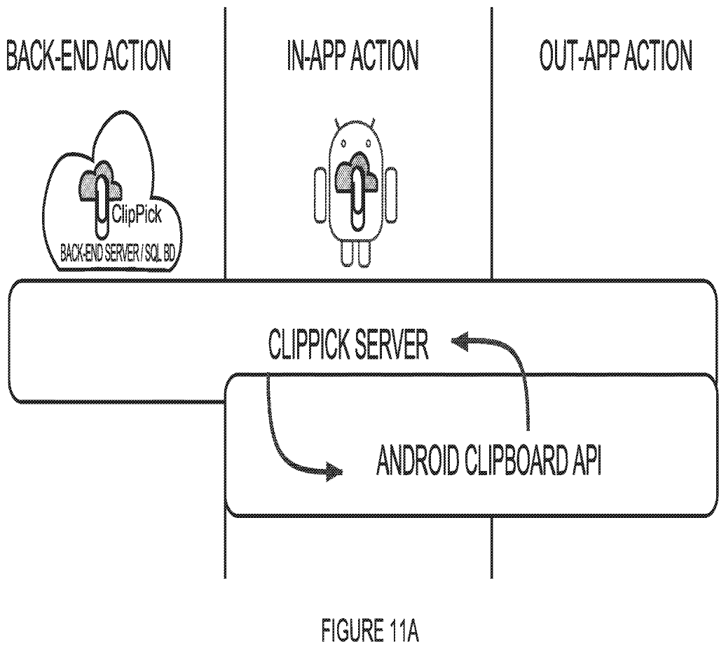

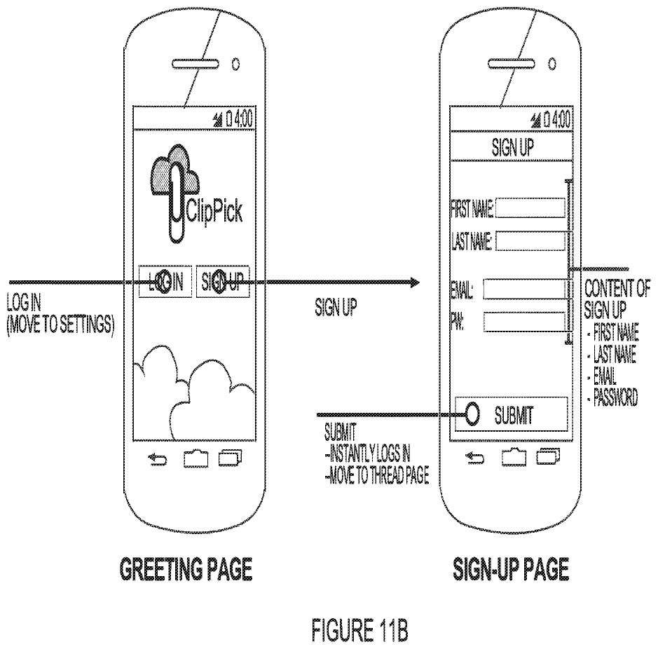

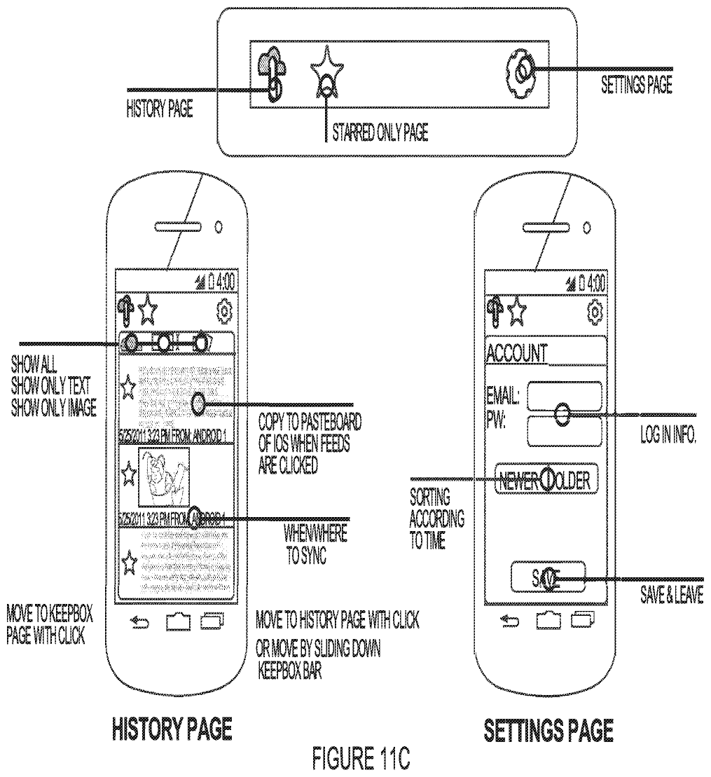

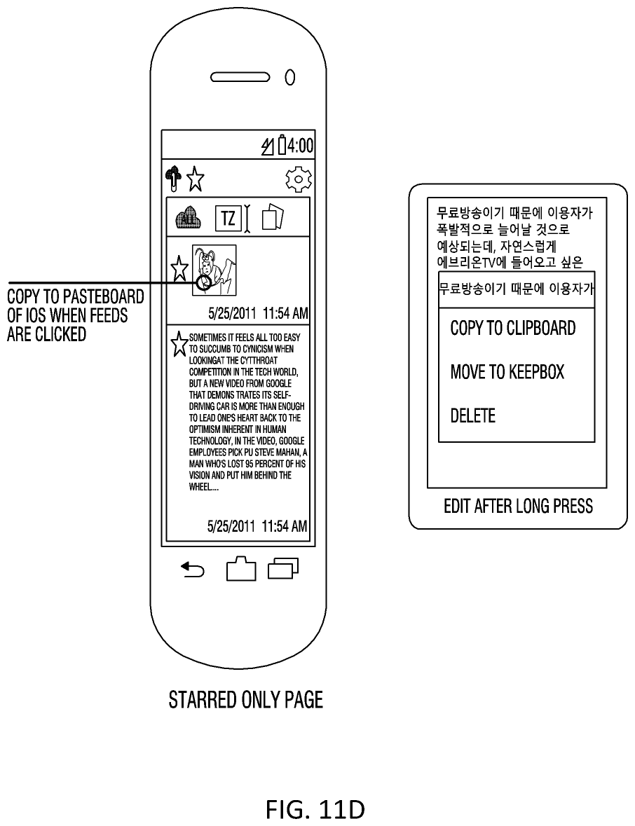

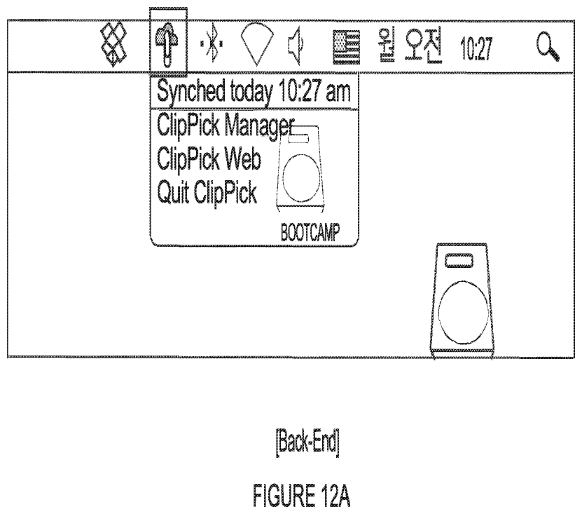

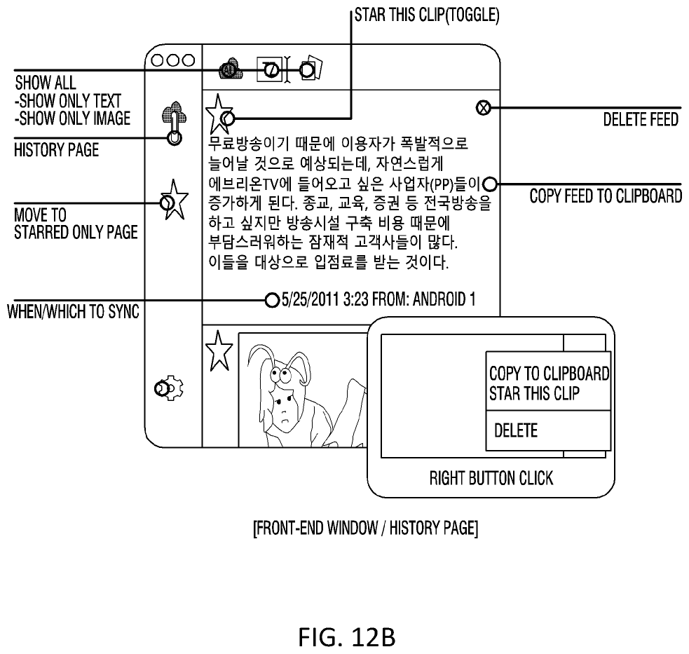

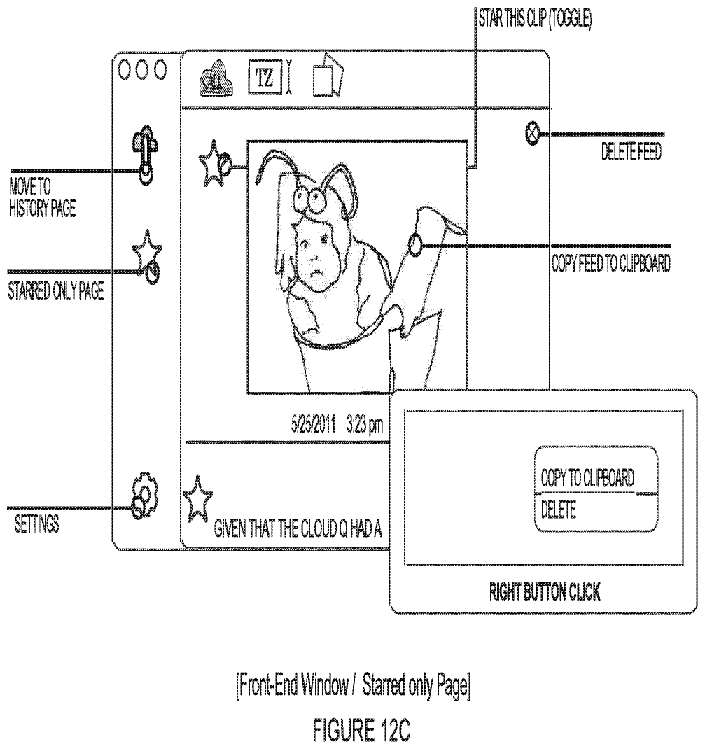

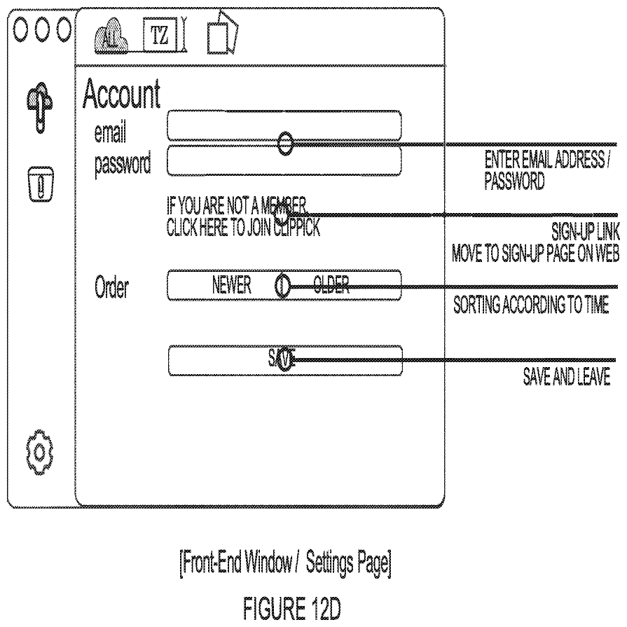

Hereinafter, embodiments of a synchronization system are described and illustrated for different operating systems (or open source platform) of each client terminal. Specifically, the client terminal of FIGS. 8A-B is a web client, the client terminal of FIGS. 9A-D is an Apple Computer iOS client, the client terminal of FIGS. 10A-D is a WINDOWS client, the client terminal of FIGS. 11A-D is an Android client, and the client terminal of FIGS. 12A-D is a MAC OS client.

As shown in FIGS. 8A-B, the web client is an example of the client terminal 100 running a web browser on the processor in which the OS, web browser, and web client are used in a linked method. As a result, the client functionality is operated through web browser that may be done with various different operating systems of client terminal 100. The web client manages feed(s) cut or copied from the web, and generally may be based, for example, on HTML 5. The web client may provide a webpage as in FIG. 8a when accessing the website for the first time. As shown in FIG. 8a, ‘ClipPick’ denotes the synchronization system 200. The user's login record is recorded after the first login. Furthermore, only the web browser is automatically exited when the user does not logout, and afterwards when re-accessed at synchronization system 200 through client terminal 100, the login condition is maintained.

For example, if a history page listing feeds is displayed after login, when the web client is implemented, a feed of client terminal 100 may be uploaded through a web browser to synchronization system 200 once every second. In this case, on the terminal side or system side, a test is run to determine if the feed is novel. If the feed is novel, then the feed is transmitted to another client terminal 100 that shares a common account (i.e., common e-mail address), and saved at system clipboard 110 of client terminal 100 that received the feed. In addition, after logging in each feed is displayed through a history page, and the user may delete, copy to the keep box 170 or another terminal, or sort the displayed feed. As described, there are various forms of sorting such as sorting by time, sorting by feed format, and sorting by client terminal.

An example of the general layout of the web page in the web client is shown in FIG. 8b. In the user interface, each feed on the history page displays a total of three pieces of information: the equipment synchronized (‘sync’), time of synchronization, and content synchronized, and is able to conduct operations such as feed delete, feed copy, and copy to keep box 170. A drag and drop motion is permitted while moving to keep box 170 so that, after clicking on the corresponding feed, if a motion is made to move to keep box 170, ‘move to keep box’ command is implemented. In addition, if the feed length exceeds 100 characters (including spaces) it is automatically copied to keep box 170.

The keep box may be limited to a particular numbers of feeds. For example, the keep box 170 may be limited to 50 feeds. Then, if a command to add a new feed is made when keep box 170 is in full condition with all 50 feeds, a warning is sent to the user rather than accepting the feed. In order to add a new feed to keep box 170 when it is full, the system will require an already stored feed to be deleted to empty the keep box 170. In condition where history page is displayed, if a new feed is created at another client terminal to update on web client, the new feed is copied (i.e., saved) real-time at system clipboard of client terminal 100 that is browsing as above.

Next, as shown in FIGS. 9A-D, an iOS client denotes the open source platform loaded on products such as iPhone and iPad of Apple Computer Inc. wherein, unlike other platforms, iOS is not able to synchronize with the synchronization system 200 in a background motion (or background sync) condition. In App Store of Apple Inc., such background motion is limited by policy, thus as shown in FIG. 9a, for synchronization with the synchronization system 200, a user application must be launched as a foreground condition.

As shown in FIG. 9B, synchronization may be made only with foreground condition on iOS. As a result, when a novel feed is formed by cutting or copying at the concerned iOS client terminal and needs to be transmitted to another client terminal 100, a push notification is generated by the push notifier 180. Similarly, when a feed is formed at another client terminal 100 and it needs to be received, push notification is made through the prior discussed push notifier 180. Such function may be set to be used at ‘setting page’ provided by client terminal 100, and the user decides whether to use push notification.

As shown in FIG. 9C, a greeting page and a sign-up page may be provided through client terminal 100, wherein greeting page is provided when the client element of the system is launched. For example the greeting page may consist of two buttons such as login and sign-up, and if logged in before, automatic login into the corresponding account without clicking any button is made, and moves to the history page. On the other hand, if the client element is launched for the first time, the greeting page stands by until one of the two buttons are clicked, moves to setting page if login is selected, and moves to sign-up page if sign-up is selected. At the sign-up page, the user enters first name, last name, e-mail address and password, and if submit button is clicked said content is entered and an account is made at the server on back-end, such pieces of information being saved in account storage device 220.

As shown in FIG. 9D, through client terminal 100 setting page and push notification page are provided, setting page being provided when clicking the login button as above. On the setting page, the user's e-mail address and password appear, and as described above, a sorting method (such as ascending order/descending order) may be selected and saved on the page. After the setting is finalized, the save button may be clicked to save the selected content, sorting information corresponding to time is saved in the corresponding client terminal 100. Even when not saved, it is possible to return to the history page by clicking the ‘ClipPick’ or ‘KeepBox’ logo on the top to change settings real-time.

On the push notification page, if a novel feed is formed by cutting or copying at the iOS implemented client terminal and it is necessary to transmit to another client terminal 100, push notification is set to be conducted as selected by the user. In addition, if a feed is formed at another client terminal 100 and it is necessary to receive this, push notification is set to be conducted as selected by the user. In addition, the iOS client terminal history page and keep box 170 are provided and these functions identical to those explained with reference to FIG. 8b, thus detailed explanation for these will be omitted hereinafter.

As shown in FIG. 10, WINDOWS client denotes the OS of Microsoft, generally the client terminal 100 being a personal PC 100c. As shown in FIG. 10a, the WINDOWS client may include a front-end and a back-end and the back-end shows a drop-up menu when clicking the icon placed on the lower menu bar. The drop-up menu consists of time and date feed is synchronized, ‘ClipPick Manager’ button which can bring front end window, ‘ClipPick Web’ button which can bring web client on a web browser, and ‘Quit ClipPick’ which can exit an application itself.

As shown in FIG. 10b, if ‘ClipPick Manager’ button is clicked, the front end window appears, and on this front end window a history page listing feeds is included. Also, as described above it is possible to get into keep box page of FIG. 10c or setting page of FIG. 10d from the front end window, and the function related to keep box 170 or setting is identical to explanations above.

As shown in FIG. 11, Android client denotes a Google Android open source platform provided by Google. Unlike the iOS implementation, the Android implementation is able to synchronize with the synchronization system 200 even in background motion (or background sync) condition so that each system clipboards 110 may be synchronized even when the client element 120 is not launched. Therefore, in Android client as shown in FIG. 11a, the newest feed is copied (i.e., saved) at the Android system clipboard 110 regardless of whether if the corresponding client element is operating as foreground. Also, regardless of whether the corresponding client element is operating as foreground, if there is change in feed saved at the Android system clipboard 110, it is updated to enable transmission to another client terminal 100. In addition, even at the Android client terminal 100 as shown in FIG. 11b, greeting page and sign-up page are provided and the greeting page is shown when the client element is launched.

As shown in FIG. 11c, history page and setting page are provided when a provided button is clicked, and in case of another client terminal 100, if any one feed is selected from the provided history page it will be saved at system clipboard 110 of the other concerned client terminal 100. As shown in FIG. 11d, if the feed on the history page is clicked for a long time, three options such as ‘Copy to Clipboard’, ‘Star this clip’, and ‘Delete’ are created, thereby enabling commands to be made more conveniently. In other words, if ‘Copy to Clipboard’ is clicked, the feed clicked for a long time will be saved at Android's system clipboard 110, if ‘Delete’ is clicked feed will be deleted from the history page, and if ‘Star this clip’ is clicked the corresponding feed will be star checked to be stored long-term. Once the star checked, on the feeds listed on the history page, a ‘.star-solid.’ shape will be created on the left top of the feed, and a feed with such ‘.star-solid.’ shape formed will automatically be saved at keep box 170 and stored long-term. Feeds saved at keep box 170 are also able to be sorted by time such as in ascending/descending order, and by feed format such as All/Text Only/Image Only.

As shown in FIG. 12, MAC OS client denotes Macintosh of Apple Inc., generally the client terminal 100 being a personal PC 100c using Macintosh. As shown in FIG. 12a, MAC clients also are distinguished into two forms, front-end and back end, the case of back-end locating at an upper menu bar on the top of the OS, showing a drop-down menu when clicking on the icon. The drop-down menu consists of time and date feed is synchronized, ‘ClipPick Manager’ button which can bring front end window, ‘ClipPick Web’ button which can bring web client on a web browser, and ‘Quit ClipPick’ which can exit the client element itself. As shown in FIG. 12b, if ‘ClipPick Manager’ button is clicked, said front end window appears, and on this front end window a history page listing feeds is included. It is also possible to move to a starred only page as in FIG. 12c and a setting page as in FIG. 12d from the front end window above, and the function for setting initial values including starred only pages which automatically save feeds that formed ‘.star-solid.’ shapes at keep box 170 and push notification settings.

In one implementation, the feeds in the system may be divided into two categories which are a feed with a piece of text only and a feed with an image only. The feeds are stored in a single MySQL table that is part of the synchronization system described above with each feed having identical numbers given to them. The feeds of a user may be stored in two queues. A first queue may be used to store a user's normal feed which can store maximum of 10-100 feeds. The second queue may be used for storing only starred feed which can store feeds with a maximum of number of stars of each user. The queues may be operated in FIFO (First In First Out) manner so that the oldest feed from the normal feed queue gets popped out when the 11th feed (for a first queue that holds 10 feeds) gets pushed into the queue. When the synchronization system sends user's feed results to the clients, the synchronization system sorts the two queues with their identical numbers and then stores the feeds in a MySQL database table in chronological order. The synchronization system may use server-side script to perform these operations.

While the foregoing has been with reference to a particular embodiment of the invention, it will be appreciated by those skilled in the art that changes in this embodiment may be made without departing from the principles and spirit of the disclosure, the scope of which is defined by the appended claims.

What is claimed is:

1. A system for synchronizing a clipboard of one or more client terminals, the system comprising:
a first client terminal configured to cut and copy particular data;
a second client terminal configured to share a common account with the first client terminal
a storage device configured to receive and save a feed created when the first client terminal cut and copy the particular data; and
a synchronization computer system, coupled to the storage device, configure to transmit the feed saved in the storage device to the second client terminal,
wherein each of the first client terminal and the second client terminal has a system clipboard for the feed cut and copied between two different applications running on each client terminal and an application clipboard for the feed being cut and copied between the same application.
